(19) United States
(12) Patent Application Publication
(10) Pub. No.: US 2011/0264482 A1
(43) Pub. Date: Oct. 27, 2011

(54) RESOURCE MATCHING

(76) Inventors: Maher Rahmouni, Bristol (GB); Claudio Bartolini, Palo Alto, CA (US); Andrew Byde, Cardiff (GB)

(21) Appl. No.: 12/765,471

(22) Filed: Apr. 22, 2010

(51) Int. Cl. G06Q 10/00

(52) U.S. Cl. 705/7.26; 705/348; 705/7.12

(57) ABSTRACT

Methods, computer-readable media, and systems are provided for resource matching. One computer-implemented method for resource matching includes logically arranging a plurality of relationships between a number of tasks and a quantity of resources for performing tasks into a multi-dimensional augmenting tree order by establishing an un-matched task from a multi-dimensional bipartite graph matching solution is established as a root node, adding additional edges and nodes beginning from the root node with an un-matched edge and alternating between matched and un-matched edges until a color-unmatched resource is a leaf node, modifying the multi-dimensional augmenting tree order by un-matching matched edges and matching un-matched edges, and determining a quantity of matched edges for the modified multi-dimensional augmenting tree order. The relationships correspond to edges of the multi-dimensional bipartite graph matching solution between nodes, representing tasks, and resources respectively.

### BACKGROUND

Resource matching is a common problem involving allocation of limited resources in an efficient manner. The resource matching problem can present itself in numerous ways, and involve a wide variety of limiting criteria to be considered in finding solutions. Some examples of resource matching problems include matching people to tasks, and matching physical resources to jobs utilizing the resources, such as assigning aircrafts to scheduled flights, allocating bandwidth to radio stations, and scheduling computing devices to run software applications. Other problems that can benefit from resource matching include optimizing register allocation during computer program compiling (e.g., such that the most frequently used values of the compiled program are stored in the fast processor registers), and pattern matching applications (e.g., coding and un-coding messages)

Some of the attributes of high quality resource matching include fast speed, maximized matching, respecting limiting criteria, accommodation of established priorities, flexibility, and consideration of secondary objectives. Various previous approaches have been used to resolve resource matching problems, including Integer Linear Programming approaches, bipartite graph matching, and brute force trial and error methodologies. However, some methodologies are not sufficiently time-efficient for use in real-time applications. Some previous approaches can produce good quality (matching) results in acceptably short periods of time, but can become trapped in local optima, and/or can produce worst-case scenarios that are not useful. Some are adept at finding maximum matching, but are too complex and/or too slow to be deployed in real time against complex problems that are also dynamic in nature.

### BRIEF DESCRIPTION OF THE DRAWINGS

FIG. 1 is a task scheduling diagram including multiple time closures, according to one or more embodiments of the present disclosure.

FIG. 2 is a task scheduling diagram within a single time closure, according to one or more embodiments of the present disclosure.

FIG. 3 is a multi-dimensional bipartite graph corresponding to the task scheduling diagram of FIG. 2, according to one or more embodiments of the present disclosure.

FIG. 4 illustrates one possible matching solution in multi-dimensional bipartite graph corresponding to the task scheduling diagram of FIG. 2, according to one or more embodiments of the present disclosure.

FIG. 5 is a multi-dimensional augmenting tree diagram corresponding to the multi-dimensional bipartite graphs of FIGS. 4 and 6, according to one or more embodiments of the present disclosure.

FIG. 6 illustrates final matching in multi-dimensional bipartite graph corresponding to the modified multi-dimensional augmenting tree diagram of FIG. 5, according to one or more embodiments of the present disclosure.

FIG. 7 is a diagram illustrating a progression of multi-dimensional bipartite graph matching solutions, according to one or more embodiments of the present disclosure.

### DETAILED DESCRIPTION

Methods, computer-readable media, and systems are provided for resource matching. One computer-implemented method for resource matching includes logically arranging a plurality of relationships between a number of tasks and a quantity of resources for performing tasks into a multi-dimensional augmenting tree order. The relationships correspond to edges of a multi-dimensional bipartite graph matching solution between nodes representing tasks and resources respectively. First, an un-matched task from the multi-dimensional bipartite graph matching solution is established as a root node. Additional edges and nodes are added beginning from the root node with an un-matched edge and alternating between matched and un-matched edges until a color-unmatched resource is a leaf node. The multi-dimensional augmenting tree order is modified by un-matching matched edges and matching un-matched edges. Finally, a quantity of matched edges for the modified multi-dimensional augmenting tree order is determined.

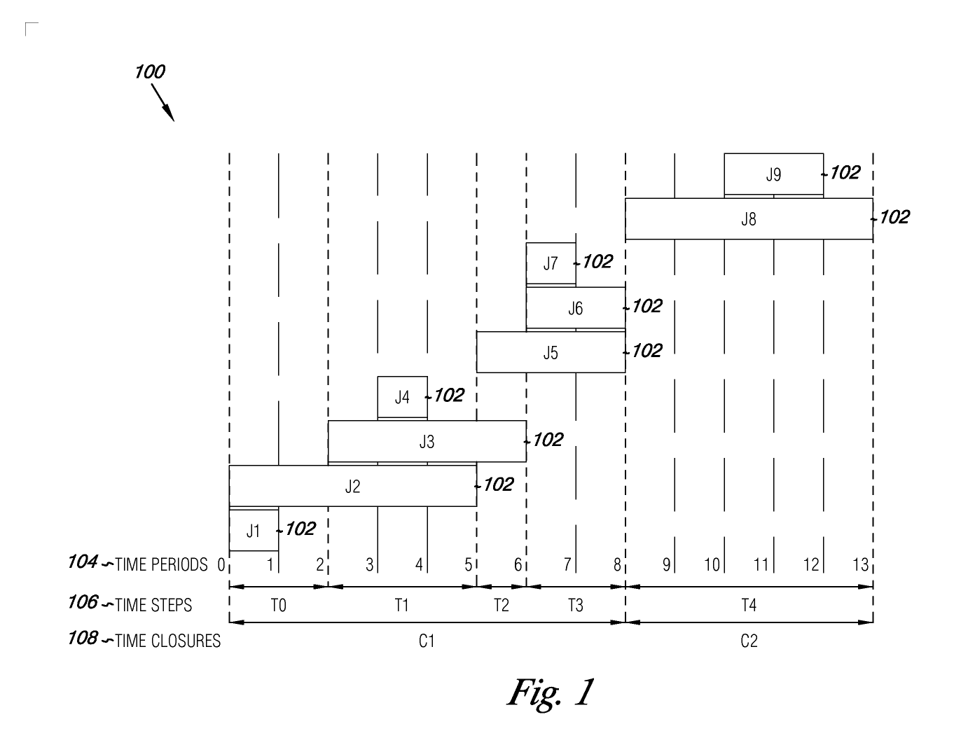

FIG. 1 is a task scheduling diagram including multiple time closures, according to one or more embodiments of the present disclosure. The task scheduling diagram 100 illustrated in FIG. 1 shows a number of tasks 102 (e.g., jobs J1-J9) scheduled over time. Tasks are not limited to jobs, a term typically used in referring to processing activities performed by computer. While the discussion that follows, and the accompanying illustrations, utilizes the term “jobs” in describing the concepts and features of the present disclosure, tasks may include activities by other terminology that can be accomplished over time. Time is divided up into time periods 104. One or more time periods 104 (e.g., 0-13) are grouped together into time steps 106 (e.g., T0-T4), and one or more time steps 106 are further grouped together into time closures 108 (e.g., C1 and C2). Time steps 106 and time closures 108 are further defined below.

Individual jobs 102 may be performed using a suitable resource (not reflected in FIG. 1). The collection of jobs may be performed using one or more suitable resources. The task scheduling diagram 100 can reflect a desired scheduling arrangement (e.g., without consideration of available resource matching), or may reflect a scheduling arrangement to be implemented based on the available resources. That is, the task scheduling diagram 100 shown in FIG. 1 can illustrate a time scheduling problem to be solved, or a resultant time scheduling solution.

Jobs 102 are shown in FIG. 1 each having duration of one or more time periods 104. A particular time period 104 may have more than one job 102 scheduled therein. While not shown in FIG. 1, some time periods 104 may not have any jobs 102 scheduled therein. That is, every time period does not have to have a job scheduled therein.

One resource matching problem of interest occurs in the allocation of shared computing resources across an organization (e.g., enterprise), such as might occur for software application testing and collaboration to achieve more performance testing in less time. For example, a large and/or complex organization may have an enterprise-wide testing platform. A centralized control is established to coordinate use of computing resources deployed across the entire enterprise such that they may be shared, and thus utilized more efficiently for the organization as a whole. However, such sharing creates a problem of coordination, and requires appropriate scheduling of computing resources, some of which may be suitable for running particular jobs, and not suitable for running others.

The coordination problem can be very complex, demanding the efficient allocation of computing resources for possibly hundreds of thousands of jobs on thousands of computing resources across months of real time, for example. Depending on the sets of capabilities and constraints involved, such scheduling problems of this sort can be very difficult to solve, being NP-complete. NP-complete problems are a class of problems that are so difficult that even the best solutions cannot consistently determine their solutions in an efficient way. In theoretical terms, NP-complete problems refer to those problems that are solved in polynomial time, such as by using a computer capable of making guesses and checking them in polynomial time (e.g., a nondeterministic Turing machine).

One example enterprise-wide testing platform can provide users an ability to configure, edit, and run tests (e.g., of software applications) using an available pool of physical computing resources, each of which can be used by at most one job at a time. A user desiring to run a particular software application test might choose the type and quantity of computing resources required for the particular test. The user may also have to specify other parameters involved in the scheduling problem, such as the estimated amount of time that is forecast to be needed for the testing involved (e.g., job). Users may specify whether a job is to start immediately (e.g., as soon as possible), or whether they wish to reserve computing resources for a particular specified later time (e.g., make a reservation for access to computing resources in the future).

Different users may have different priority access to the one or more of the computing resources (e.g., computing resources may be dedicated to a particular portion of an organization or procured in support of a particular business purpose, etc.), and/or may have different levels of control over certain scheduling attributes. For example, certain users may have administrator privileges, such that they can modify the pool of resources available, or certain particular portions of the pool of computing resources. Thus, a scheduling solution may have to accommodate a complex set of priorities and limiting conditions.

The scheduling problem presented is dynamic, as new jobs need to be scheduled, jobs are completed, resources are added or removed from the pool, and/or priorities of users or jobs shift. Some scheduling issues and/or resource management issues, such as resource pool modifications, may require reallocation, or possibly cancellation of existing computing resource reservations. Therefore, a resource matching solution must efficiently address the real-world constraints and complications.

The resource matching methodology and system of the present disclosure is relatively fast in comparison to previous approaches, typically yielding a solution to a particular complex resource matching problem within a few seconds depending on the complexity of the resource matching problem being addressed. Therefore, it can be deployed on-line in real time. It can accommodate multiple users accessing and using the system simultaneously since re-allocation of resources due to a change in jobs and/or resources is compartmentalized into a smallest possible time period. That is, re-allocation is time-limited such that only a portion of the entire scheduling problem need be re-computed.

Furthermore, the resource matching methodology and system of the present disclosure is efficient in that it maximizes the quantity of job matches. While it may not always be possible to find a complete resource matching solution in all cases given the complex nature of some scheduling problems with respect to a given amount of computing resources, maximizing resource matching facilitates the highest possible efficiency in utilizing available computing resources.

While the resource matching methodology and system of the present disclosure is described in the context of matching software application jobs to computing resources suitable for running particular jobs, embodiments of the present disclosure are not limited to the example application, and may be applied to other types of resource matching problems, and implemented by, and as part of, other systems.

Referring again to FIG. 1, time is divided up into time periods 104, which are further arranged into time steps 106, which are further arranged into time closures 108. As shown in FIG. 1, time step T0 includes time periods 1 and 2, time step T1 includes time periods 3-5, etc. Time closure C1 includes time steps T0-T3, and time closure C2 includes time step T4. However, embodiments of the present disclosure are not limited to the arrangement of time steps and time closures shown in FIG. 1. The particular arrangement of time steps and time closures are determined from the collection of scheduled jobs, as will be appreciated from the following discussion.

Time starts at time 0 and is divided into time periods 104. Time period 1 is defined to include the time from time 0 to time 1. In some embodiments, time periods 104 can be defined by a particular interval of time (e.g., a shortest duration of time during which it is possible to schedule a job 102). In various embodiments, time periods 104 can be defined as lengths of time equal to the length of time required to complete a job 102 having a shortest duration. For example, in FIG. 1, jobs J1, J4, and J7 have the shortest duration of time for completion, thus the time period increment is defined by the duration of those jobs J1, J4, and J7.

A time step is the largest period of consecutive time period where all jobs overlap. Jobs need not overlap for the entire duration of the time step, rather each job within a particular time step must overlap each other job(s) within the particular time step. Furthermore, each time step includes at least one completed job. The reader will appreciate that a job that starts at or after the completion of a prior job does not overlap the prior job, and thus, cannot be located within the same time step as the completed prior job. The only exception is the first job, since there are no jobs that supersede (e.g., are completed before) the first job.

Time steps are non-overlapping intervals of time. Jobs may traverse time steps (e.g., cross a boundary between two time steps). However, every job that traverses two time steps 106 overlaps with all other jobs within each of the two traversed time steps 106. In one or more embodiments, the beginning of a time step 106 can be defined as either the beginning of the first job, or the ending of the previous time step. Due to the job overlap constraints of a time step discussed above, time step boundaries usually occur at the beginning or end of a job.

For example, referring to FIG. 1, jobs J1 and J2 start at time 0, and overlap one another in time period 1. Time step T0 starts at time 0 (e.g., at the start of a first job). Job J2 also begins at time 0 and traverses time steps T0 and T1. By definition, job J2 overlaps all other jobs in T0 and T1. Time step T0 cannot extend beyond the start of job J3 because job J3 would not overlap all jobs in T0 (e.g., job J3 does not overlap job J1). Therefore, time step T0 ends at the start of job J3. Therefore, time step T1 starts at the start of job J3, as shown in FIG. 1. Similarly, time step T1 cannot extend beyond the start of job J5 because job J5 would not overlap all jobs in time step T1 (e.g., job J5 does not overlap job J4, which is also in time step T1). Time step T1 can extend beyond the start of job J4 since job J2, which traverses time steps T0 and T1 does overlap job J4 in time step T1, and thus satisfy the requirement that every job that traverses two time steps 106 overlaps with all other jobs within each of the two traversed time steps 106.

As shown in FIG. 1, J2 traverses time steps T0 and T1, and overlaps with all jobs in each of time step T0 (e.g., job J1) and time step T1 (e.g., jobs J3 and J4). Note that job J2 does not overlap job J5, and as mentioned above, time step T1 cannot extend in time to include any portion of job J5.

The reader will appreciate that time steps are defined by the particular durations and arrangement of the jobs to be accomplished. Therefore, as the arrangement and/or length of jobs change, the arrangement of time steps (and time closures described below) can change.

As can be seen from FIG. 1, job J3 traverses time steps T1 and T2, overlapping all other jobs in T1 (e.g., jobs J2 and J4), and overlapping at least job J5 in time step T2. By definition, every job that traverses two time steps 106 overlaps with all other jobs within each of the two traversed time steps 106. Therefore, job J3 must overlap with all jobs in time step T2. Since job J3 does not overlap jobs J6 and J7, time step T2 cannot extend into time period 7 which contains jobs J6 and J7, and thus ends at the end of time period 6.

Time closures 108 are defined as a set of consecutive time steps 106 where each two adjacent time steps within a particular time closure have at least one job in common (e.g., at least one job occurs during adjacent time steps). Time closures have boundaries at time steps that have no overlapping jobs. In FIG. 1, no jobs overlap between time steps T3 and T4, so they are in different time closures. Therefore, time closure C1 extends from time 0 to time step T3, and time closure C2 begins with time step T4, and extends to the end of the task scheduling diagram 100 (e.g., through time step T4).

According to one or more embodiments of the present disclosure, resource matching is independent between closures. That is, if a new job arrives, or an existing job is removed, only the closure to which that job belongs (assuming it resides completely within one closure) needs to undergo revised resource matching (e.g., re-allocation of resources).

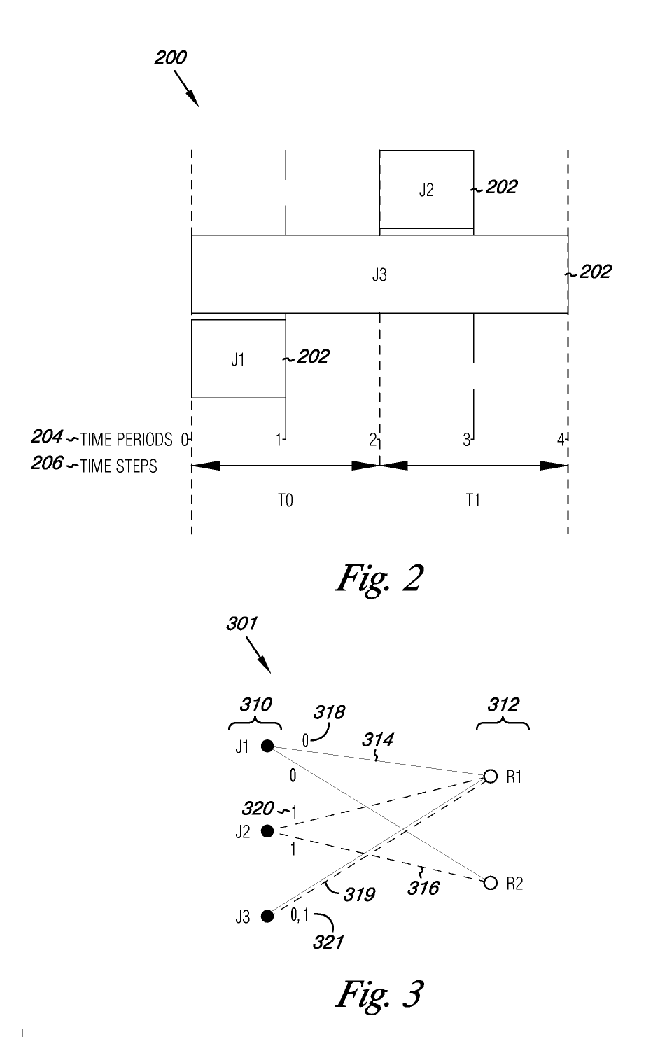

FIG. 2 is a task scheduling diagram within a single time closure, according to one or more embodiments of the present disclosure. The task scheduling diagram 200 presents a relatively simple resource matching problem to illustrate the principles and features of the present disclosure. The reader will appreciate that the methods and systems described herein can be applied to different, and more complex, resource matching applications. Again, the examples that follow attempt to match a number of software application jobs to a number of suitable computing resources for running the jobs.

FIG. 2 shows an example set consisting of three jobs 202 (e.g., J1-J3) in a single time closure for simplicity in illustrating the following aspects of the present disclosure. Task scheduling diagram 200 includes four time periods 204 (e.g., 1-4) and two time steps 206, with time step T0 including time periods 1 and 2, and time step T1 including time period 3 and 4. Job J3 traverses time steps T0 and T1, and overlaps all jobs in T0 (e.g., job J1) and all jobs in T1 (e.g., job J2).

The resource matching problem illustrated in FIG. 2 is further constrained by the resources available to accomplish jobs J1-J3. Not only is the quantity of resources limited, but also the suitability of the resources to accomplish certain jobs is limited as set forth in Table 1.

TABLE 1

| Jobs | Suitable Resources |
|---|---|
| J1 | R1 or R2 |
| J2 | R1 or R2 |
| J3 | R1 |

The resource matching problem between jobs, suitable resources, and time steps, as defined by task scheduling diagram 200 and the suitable resource availability summarized in Table 1 can be set forth on a multi-dimensional (e.g., colored) bipartite graph.

Graph coloring is a special case of graph labeling. Graph coloring is an assignment of labels, traditionally called “colors” to elements of a graph subject to certain constraints. Coloring codes elements of a graph such that no two adjacent like elements share a same color. In visually-displayed graphs, color can be used to color the components of a graph. In computer-implemented graphing solution, coloring can be accomplished by tracking the constraints (e.g., attributes) using codes, flags, variables, or other such information.

Colored bipartite graphs are so-named for using color to convey one or more additional dimensions of information, beyond that which can be conveyed by a two-dimensional black and white bipartite graph. Although the examples and descriptions are presented herein in black and white, embodiments of the present disclosure are not so limited. For example, the solid and dashed lines used herein to designate particular time steps could be implemented as solid lines of differing colors (e.g., a colored bipartite graph). Of course, the presentations of graphical bipartite graphs are intended to facilitate human understanding, and one having ordinary skill in the art will recognize that the methods of the present disclosure may be computer-implemented with, or without, the graphical diagrams being output. That is, a computing device can calculate and track the information set forth in the multi-dimensional bipartite graph using a corresponding quantity of variables, flags, and other settings.

Accordingly, the conventional term of colored bipartite graphs are referred to herein as multi-dimensional bipartite graphs since use of color in calculating, arranging, and/or displaying the information contained in a colored bipartite graph can be implemented without the use of color. The discussion above also applies herein to augmenting tree diagrams. That is, augmenting tree diagrams that typically convey some information using color are referred to herein as multi-dimensional augmenting tree diagram since embodiments of the augmenting tree diagrams of the present disclosure are not limited to augmenting tree diagrams having color. Certain information may be conveyed using pattern (e.g., solid, dashed), or accounted for in computer-implemented methods by variables, flags, or other settings.

FIG. 3 is a multi-dimensional bipartite graph corresponding to the task scheduling diagram of FIG. 2, according to one or more embodiments of the present disclosure. The matching problem generated by the job scheduling shown in FIG. 2 and the resource availability and suitability shown in Table 1 is represented in the multi-dimensional bipartite graph 301 shown in FIG. 3. The vertices 310 on the left side of the multi-dimensional bipartite graph 301 represent jobs. The vertices 312 on the right represent resources. The resource matching problem consists of finding a matching between the jobs and resources such that more than one job are not allocated to the same resource at the same time.

The job scheduling problem described by the job schedule shown in FIG. 2 and the resource constraints provided in Table 1 are modeled together in FIG. 3. FIG. 3 illustrates a simple, yet non-trivial problem that the reader can quickly appreciate has more than one possible solution. Some of the possible solutions do not result in all the jobs being completed. That is, since there are more jobs than computing resources, a complete matching solution will necessarily involve utilizing at least one resource to accomplish more than one job. Therefore, any solution that will complete all jobs will require the shared resource to be scheduled in time between the multiple jobs.

Edges (e.g., lines representing relationships between vertices) of the multi-dimensional bipartite graph 301 represent resource requirements and time steps are represented by colors over the edges. Edges can have more than one color. As the multi-dimensional bipartite graph 301 is depicted here in black and white, rather than color, a first “color” is represented by solid lines (e.g., 314) and a second “color” is represented by dashed lines (e.g., 316). The events of a particular time step are represented by a corresponding “color.” In FIG. 3, the events of time step T0 are represented by associated edges being shown by the solid line “color” designation, and the events of time step T1 are represented by associated edges being shown by the dashed line ‘color” designation.

Each edge is further labeled with the time step within which the corresponding job is contained. For example, edge 314 is shown with a solid “colored” line, further designated with a time step label 318 of 0, since job J1 occurs in time step T0. Edge 316 is shown with a dashed “colored” line, and further designated with a time step label (e.g., 320) of 1, indicating that job J2 occurs in time step T1. Edge 319 is shown with both a solid and dashed “colored” lines, and further designated with a time step label 321 of “0, 1” to indicate that job J3 occurs in both time steps T0 and T1 (e.g., spans time steps T0 and T1).

In the mathematical field of graph theory, a bipartite graph is a graph whose vertices can be divided unto two disjoint sets such that every edge connects a vertex in one set (e.g., left side of the bipartite graph) to a vertex in a second set (e.g., right side of the bipartite graph). That is, the two sets are independent.

Bipartite graphs are useful for modeling matching problems. In computer science applications, one mathematical modeling tool used in analysis and simulations of concurrent systems is a bipartite directed graph with two sets of nodes: a set of “place” nodes that represent resources, and a set of “event” nodes that generate and/or consume resources. This arrangement is sometimes referred to as a Petri net.

In the case illustrated in FIG. 3, the sets to be matched are jobs (e.g., J1, J2, J3) to be completed, indicated by the solid vertices on the left, and available computing resources (hereinafter “resources,” e.g., R1, R2) that can process certain jobs, indicated by the hollow vertices on the right.

One resource matching limitation can be that not all resources are necessarily suitable for performing all jobs. The limitations for the example scheduling problem depicted in FIG. 2 are summarized in Table 1. Such limitations are modeled in a bipartite graph as an edge between a particular job and a resource that is suitable to perform that particular job. For example, job J1 has edges to each of resources R1 and R2, indicating that either resource is suitable to perform job J1. Likewise, job J2 has edges to each of resources R1 and R2, indicating that either resource is suitable to perform job J2. However, since job J3 can only be performed by resource R1, job J3 only has an edge to resource R1, and does not have an edge shown in the bipartite graph of FIG. 3 to resource R2.

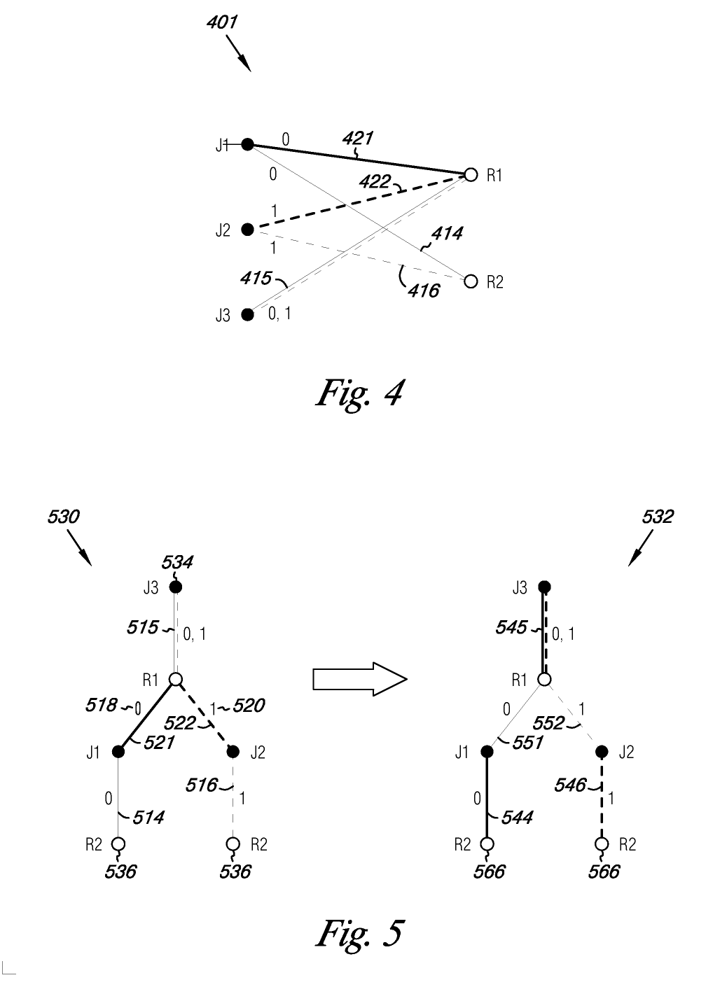

FIG. 4 illustrates one possible matching solution in multi-dimensional bipartite graph corresponding to the task scheduling diagram of FIG. 2, according to one or more embodiments of the present disclosure. Matching on a bipartite graph is called bipartite matching. On the multi-dimensional bipartite graph 401 illustrated in FIG. 4, matching is indicated by a thicker edge (e.g., thicker solid line, thicker dashed line), representing a particular job at one end of an edge being performed by a particular resource at the other end of the edge. That is, for solid “color” lines (representing events within time step T0) a matching is indicated by a thicker solid line (e.g., 421), and for dashed “color” lines (representing events within time step T1) a matching is indicated by a thicker dashed line (e.g., 422).

The thin (e.g., not thick) edges shown in FIG. 4 between jobs and resources indicate that a particular job at one end of the thin edge could be performed by a particular resource at the other end of the thin edge. Therefore, one possible resource matching solution, as depicted by multi-dimensional bipartite graph 401, involves job J1 being performed in T0 by resource R1 (as indicated by the thicker solid edge 421) and job J2 being performed in T1 also by resource R1 (as indicated by the thicker dashed edge 422). As indicated by the thin edges, job J1 could be performed in T0 by resource R2 (but is not being performed by resource R2 in the solution depicted in FIG. 4), and job J2 could be performed in T1 by resource R2 (but is not being performed by resource R2 in the solution depicted in FIG. 4).

The reader will understand that edge thickness, graphically indicating matching on a multi-dimensional bipartite graph, can be accounted for in a computer-implemented method by variable value, flags, or other settings. That is, the methods illustrated by the diagrams herein are not limited to graphical embodiments, and may be mathematically and/or logically implemented without a graphical output.

The possible resource matching solution illustrated in FIG. 4 leaves job J3 uncompleted. That is, multi-dimensional bipartite graph 401 shows that job 1 can be done by R1 in T0, and job J2 can be done by R1 in T1, but then job J3 will not get completed since it can only be done by resource R1. The thinner edges between J1 and R2, J2 and R2, and J3 and R1 indicated job-resource matches that are unmatched in the solution summarized in FIG. 4.

As one skilled in the art will appreciate, solving the resource matching problem using a bipartite graph methodology consists of matching jobs and resources such that there is no resource with more than one matched edge sharing a color (e.g., no two jobs matched to the same resource at the same time). In the possible solution depicted on multi-dimensional bipartite graph 401, resource R1 does not have more than one matched edge (e.g., thicker line) sharing a color (e.g., solid or dashed). The possible solution illustrated in FIG. 4 is valid because no resource with more than one matched edge sharing a color (e.g., there are not two thick solid lines or two thick dashed lines connected to any resource). However, the possible solution illustrated in FIG. 4 is not optimal because J3 is unassigned.

According to one or more embodiments of the present disclosure, high cardinality matching (e.g., a large proportion of matches) in multi-dimensional graphs can be found by searching for multi-dimensional augmenting trees derived from sub-optimal multi-dimensional bipartite graphs depicting possible solutions to the particular resource matching problem. A sub-optimal solution is one in which all jobs are not completed as scheduled, and there exists at least one augmenting tree rooted in one of the uncompleted jobs.

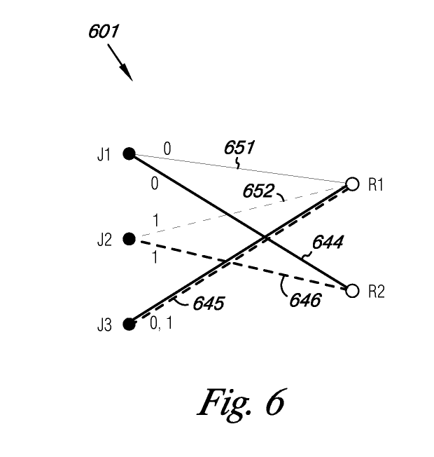

FIG. 5 is a multi-dimensional (e.g., colored) augmenting tree diagram corresponding to the multi-dimensional bipartite graphs of FIGS. 4 and 6, according to one or more embodiments of the present disclosure. The augmenting tree diagram 530 shown in FIG. 5 is constructed from the multi-dimensional bipartite graph 401 shown in FIG. 4 according to the following process. The root node 534 (e.g., starting node for the tree) is an un-matched job. From the multi-dimensional bipartite graph 401, representing one possible solution to the resource matching problem indicated by job schedule of FIG. 2 and the resource suitability summarized in Table 1, job J3 is one un-matched job, and is therefore used as the root node 534 in the augmenting tree diagram 530. An un-matched job is a job that does not have a resource to perform it, and thus, does not get completed.

Construction, as used herein, is not limited to the graphically-depicted assembly of a multi-dimensional augmenting tree diagram (e.g., 530) from a multi-dimensional bipartite graph (e.g., 401). That is, actually producing the multi-dimensional augmenting tree diagram from the multi-dimensional bipartite graph is not required. The diagrams are shown in describing the methods of the present disclosure for ease of understanding. Rather, construction is understood to mean logically arranging the relationships between the jobs and resources as can also be depicted by a multi-dimensional bipartite graph solution and/or a multi-dimensional augmenting tree diagram ordering the relationships according to an order as might be shown as branches of a tree. The reader will appreciate that a computer-implemented method can determine and relate the relationships represented in the various diagrams without having to actually produce a graphical image of the respective diagrams.

Continuing on with diagram 530 shown in FIG. 5, the tree next alternates between matched edges and unmatched edges, from the root node. Looking at the multi-dimensional bipartite graph 401 from the un-matched job J3, only one edge exists (e.g., 415) to R1, which is added to the augmenting tree diagram 530. Edge 415 is an un-matched edge. Alternating from the un-matched edge 415, matched edges 421 and 422 from R1 are next added to the augmenting tree diagram 530, which respectively terminate at J1 and J2, as shown. Alternating once again, this time from the matched edges 421 and 422, to unmatched edges from J1 and J2 respectively, un-matched edges 514 (from J1) and 516 (from J2) are added to the augmenting tree diagram 530. Each of un-matched edges 514 and 516 terminate at R2. That is, according to one or more embodiments of the present disclosure, the leaf nodes (e.g., nodes having only one edge thereto) of the augmenting tree diagram are color-unmatched resources (e.g., unused resources). Color-matched resources represent used resources in a particular possible resource matching solution.

According to one or more embodiments of the present disclosure, the un-matched edges of the augmenting tree diagram are matched, and the matched edges are unmatched to arrive at modified augmenting tree diagram. For the example illustrated in FIG. 5, un-matched segments 514, 515, and 516 in augmenting tree diagram 530 are shown in augmenting tree diagram 532 corresponding to matched segments 544, 545, and 546 respectively. Similarly, matched segments 521 and 522 in augmenting tree diagram 530 are shown in augmenting tree diagram 532 corresponding to un-matched segments 551 and 552 respectively. The arrangements of nodes (e.g., J1-J3, R1 and R2) remain unchanged from augmenting tree diagram 530 to augmenting tree diagram 532.

The reader will appreciate that in the above-described and illustrated case, by matching the un-matched edges, and un-matching the matched edges results in a modified multi-dimensional augmenting tree diagram, the quantity of matches in the modified multi-dimensional augmenting tree diagram has increased by one, thereby providing a better possible solution that depicted by multi-dimensional bipartite graph 401.

FIG. 6 illustrates final matching in multi-dimensional bipartite graph corresponding to the modified multi-dimensional augmenting tree diagram of FIG. 5, according to one or more embodiments of the present disclosure. The multi-dimensional bipartite graph 601 can be calculated by arranging the vertices (e.g., nodes) and edges according to the multi-dimensional bipartite graph 401, but with the matched and un-matched edges shown as reflected in the modified multi-dimensional augmenting tree diagram 532. That is, matched edges 644, 645, and 646 in the multi-dimensional bipartite graph 601 correspond to the matched edges 544, 545, and 546 of modified multi-dimensional augmenting tree diagram 532. Un-matched edges 651 and 652 in the multi-dimensional bipartite graph 601 correspond to the un-matched edges 551 and 552 of modified multi-dimensional augmenting tree diagram 532.

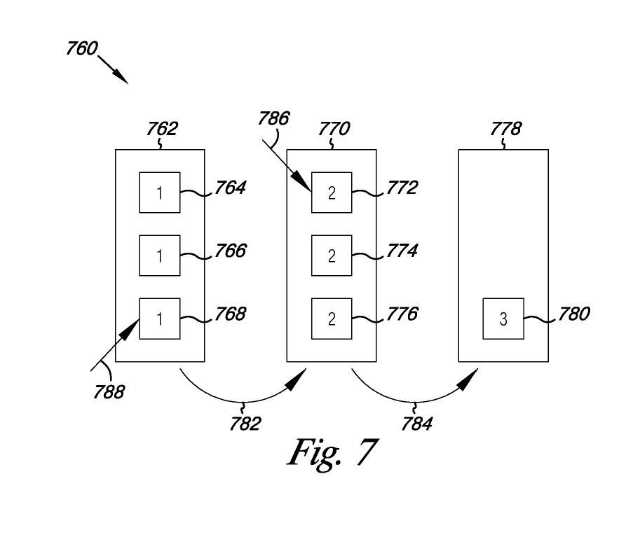

FIG. 7 is a diagram illustrating a progression of multi-dimensional bipartite graph matching solutions, according to one or more embodiments of the present disclosure. Diagram 700 graphically depicts that there is a first set 762 of possible multi-dimensional bipartite graph matching solutions, corresponding to the task scheduling diagram shown in FIG. 2, that provide only one match (e.g., only gets one job done). The first set 762 of possible solutions is shown including three solutions 764, 766, and 768, which can correspond to just completing job J1, or just completing job J2, or just completing job J3. Since it is possible to allocate resources such that more than one job can be accomplished, the first set 762 of solutions is understood to be sub-optimal (e.g., inefficient use of resources).

Diagram 700 also graphically depicts a second set 770 of possible multi-dimensional bipartite graph matching solutions, 772, 774, and 776, that result in two jobs being completed. For example, solution 772 may represent job J1 being completed in time step T0 by resource 1 and job J2 being completed in time step T1 by resource 1. The multi-dimensional bipartite graph corresponding to this possible solution is shown in FIG. 4. Solution 774, that also results in two jobs being completed, may represent job J3 being complete in time steps T0 and T1 by resource 1 and job J1 being completed in time step T1 by resource 2. Solution 776 also results in two jobs being completed, and may represent job J3 being complete in time steps T0 and T1 by resource 1 and job J2 being completed in time step T1 by resource 2. Again, since it is possible to allocate resources such that more than two jobs can be accomplished, the second set 770 of solutions is also understood to be sub-optimal (e.g., inefficient use of resources, but more efficient than solution set 762).

Finally, diagram 700 also graphically depicts a third set 778 encompassing a single possible multi-dimensional bipartite graph matching solutions, 780, that results in three jobs being completed. For example, solution 780 may represent job J3 being complete in time steps T0 and T1 by resource 1 and job J1 being completed in time step T0 by resource 2 and job J2 being completed in time step T1 by resource 2. Since all jobs are completed, the third set 778 of solutions is not sub-optimal (e.g., is an optimal solution), and provides a most efficient use of the available resources.

The method of the present disclosure is not a brute force method for arriving directly at the most optimal solution. Rather, the method of the present disclosure attempts to increment the quantity of matches by one with each iteration, starting with a possible multi-dimensional bipartite graph matching solution, finding an augmenting tree, matching un-matched edges of the tree and un-matching matched edges of the tree to arrive at another matching which increase by one the quantity of matched jobs. The reader will appreciate that by definition, an augmenting tree is a tree that augments by one the quantity of matching with respect to the multi-dimensional bipartite graph used to derive the tree. While a multi-dimensional tree diagram can always be derived from a multi-dimensional bipartite graph, the derived multi-dimensional tree diagram may, or may not, be a multi-dimensional augmenting tree. Thus, whenever a multi-dimensional augmenting tree can be found, the existing matching (e.g., from the multi-dimensional bipartite graph used to derive the multi-dimensional augmenting tree) can be augmented by one.

Entering the range of possible resource matching solutions shown in diagram 760 at one of perhaps many possible solutions is indicated by arrows 782 and 784 in FIG. 7. The example described above with respect to FIGS. 4-6 began with the possible multi-dimensional bipartite graph matching solution shown in FIG. 4. Entering the spectrum of possible solutions depicted in FIG. 7 at the sub-optimal possible solution shown in FIG. 4 is represented by arrow 786. The example described above with respect to FIGS. 4-6 then increases the quantity of matches, moving from a solution having 2 matches to a solution having 3 matches, as indicated by arrow 784.

The reader will appreciate that the method of the present disclosure could be initiated by entering the range of possible solutions at a different particular solution, as may be indicated by arrow 788 in FIG. 7. However, it will be understood that beginning with a less-optimal possible solution will require additional iterations to arrive at an optimal solution, since each iteration might increase the number of matches by one. The process described above with respect to FIG. 4-6 can be repeated, beginning with a new multi-dimensional bipartite graph matching solution corresponding to a modified multi-dimensional augmenting tree resulting from a previous iteration (e.g., constructing the new multi-dimensional bipartite graph matching solution into a corresponding multi-dimensional augmenting tree for each remaining unmatched job as a root node).

While a modified multi-dimensional augmenting tree diagram was found for the simple example resource matching problem illustrated and described above, in some instances a modified multi-dimensional augmenting tree diagram (e.g., that increases the size of multi-dimensional matching by one) may not be found for a particular un-matched job. According to one or more embodiments of the present disclosure, an attempt is made to find a modified multi-dimensional augmenting tree diagram for each un-matched job. According to some embodiments, the process can be repeated for other sub-optimal (e.g., less than optimal) solutions as well.

Where several solutions are found having equivalent quantities of matches, other criteria can be utilized to select among the several solutions to determine a best solution (e.g., includes maximum matching and satisfies one or more additional criteria). For example, possible solutions 772, 774, and 776 each represent two jobs being completed. However, the solutions that include completion of job J3 and one of jobs J1 or J2 may yield more efficient use of the resources than a solution that completes jobs J1 and J2, but not the longer job J3.

While the embodiments or the present disclosure have been described and illustrated in graphical form in this disclosure, one having ordinary skill in the art will recognize that the methods thus described are not limited to graphical representations and/or methodologies. That is, the one having ordinary skill in the art will understand how to implement the concepts illustrated graphically herein, using computing devices to find computational solutions without graphical representations or user intervention. The graphical illustrations provided herein are for ease of understanding, and for compact and simple presentation, for benefit of the reader, and are not intended to limit the embodiments of the present disclosure.

Embodiments of the present disclosure can be implemented by one or more computing devices, with or without the graphical output of the diagrams disclosed herein. For example, a resource matching system can include a non-transitory computer-readable medium communicatively coupled to the one or more computing devices. The non-transitory computer-readable medium can include instructions executable on the one or more computing devices (e.g., processors) to perform the methods described herein. The results of the methods of the present disclosure can be output to a printing device, and/or display device, and/or otherwise used to control the actual performance of particular jobs by particular resources.

Embodiments of the present disclosure can be computer-implemented, for example, using the underlying relationships. A matching is a set of color disjoint edges. An edge can be represented as (Job,Resource,Color). Two edges (J1,R1,(C1, . . . , Cn)) and (J2,R2,(K1, . . . , Km)) are disjoint if and only if:
i. J1/=J2; and
ii. (R1/=R2 or (R1=R2 and (C1, . . . , Cn) doesn't overlap with (K1, . . . , Km) meaning (C1, . . . , Cn) and (K1, . . . , Km) are disjoint sets))
   One skilled in the art will understand that (C1, . . . , Cn) not overlapping with (K1, . . . , Km) occurs only when (C1, . . . , Cn) and (K1, . . . , Km) are disjoint sets. Furthermore, ii means that either the resources are different, or the resources are the same but do not share a single color.

It should be appreciated that the number of disjoint edges is the size of the matching. The goal of the methods of the present disclosure is to find a matching with the maximum size (e.g., the greatest number of disjoint edges). Given a multi-dimensional bipartite graph, and a matching M of size n, if an augmenting tree T (as defined previously herein) can be found from the multi-dimensional bipartite graph, then the matching M (e.g., of the multi-dimensional bipartite graph) can be augmented by 1 to yield a matching M1 with a size n+1. As was described previously, and illustrated in FIG. 5, matching M1 can be constructed by matching all un-matched edges in T, and un-matching all matched edges in T.

The above-described methodology can be implemented iteratively. For example, an existing valid matching, or an empty matching, can be used as a starting point from which to begin the iterative process of searching for an augmenting tree from multi-dimensional bipartite graph. Where an augmenting tree is found, a corresponding multi-dimensional bipartite graph can be used to search for another augmenting tree. The iterative process continues until no augmenting tree can be found from a particular multi-dimensional bipartite graph (e.g., all un-matched nodes of the multi-dimensional bipartite graph are used as a root node from which a tree ordering is constructed).

While the above-described iterative process can be started from any existing valid matching, or empty matching, the reader might appreciate that if the jobs are strictly ordered (e.g., by some priority), and if the process is begun from an empty matching using a highest priority job and searching toward progressively lower priority jobs, then the above-described methodology produces a maximum matching (e.g., a matching with the maximum size possible). In this way, optimal solutions can be arrived at more efficiently if some additional information is utilized (e.g., job priority) in deciding upon a starting point for the iterative process described above.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computer-implemented method for resource matching, comprising:
logically arranging a plurality of relationships between a number of tasks and a quantity of resources for performing tasks into a multi-dimensional augmenting tree order, the relationships corresponding to edges of a multi-dimensional bipartite graph matching solution between nodes, representing tasks, and resources respectively, by:
establishing an un-matched task from the multi-dimensional bipartite graph matching solution as a root node,
adding additional edges and nodes beginning from the root node with an un-matched edge and alternating between matched and un-matched edges until a color-unmatched resource is a leaf node, and
modifying the multi-dimensional augmenting tree order by un-matching matched edges and matching un-matched edges; and
determining a quantity of matched edges for the modified multi-dimensional augmenting tree order.

2. The method of claim 1, further comprising:
repeating the method of claim 1 for each un-matched task of the multi-dimensional bipartite graph matching solution; and
determining a largest quantity of matched edges from among the modified multi-dimensional augmenting tree orders corresponding to each un-matched task being a root node thereof.

3. The method of claim 2, further comprising repeating the method of claim 2 for a multi-dimensional bipartite graph matching solution corresponding to the modified multi-dimensional augmenting tree order determined to have the largest quantity of matched edges.

4. The method of claim 1, further comprising:
determining a number of time steps from a schedule relating the tasks into a quantity of time periods, wherein a particular time step is determined as a maximum quantity of consecutive time periods such that every task occurring within the consecutive time periods overlap with all other tasks occurring within the consecutive time periods.

5. The method of claim 4, wherein the number of time steps correspond to colors over the edges in the multi-dimensional bipartite graph matching solution.

6. The method of claim 4, wherein a start of a time step occurs either at a beginning of a first task or at an end of a previous time step.

7. The method of claim 4, further comprising:
determining a number of time closures from the number of time steps, wherein a particular time closure is determined to be a set of consecutive time steps where each two adjacent time steps have at least one task in common; and
performing the method of claim 1 for a single time closure.

8. The method of claim 7, further comprising performing the method of claim 1 individually for each time closure.

9. The method of claim 8, wherein edges of the multi-dimensional bipartite graph matching solution represent suitable resource requirements for particular tasks within a single time closure.

10. A non-transitory computer-readable medium including instructions executable on a processor to:
logically arrange a plurality of relationships between a number of tasks and a quantity of resources into a multi-dimensional augmenting tree order, the relationships corresponding to edges of a multi-dimensional bipartite graph matching solution between nodes, representing tasks, and resources respectively, by:
establish an un-matched task from the multi-dimensional bipartite graph matching solution as a root node,
add additional edges and nodes beginning from the root node with an un-matched edge and alternating between matched and un-matched edges until a leaf node is a color-unmatched resource, and
modify the multi-dimensional augmenting tree order by un-matching matched edges and matching un-matched edges; and
determine a quantity of matched edges for the modified multi-dimensional augmenting tree order.

11. The non-transitory computer-readable medium of claim 10, further including instructions executable on a processor to:
repeat the executable instructions of claim 10 for each un-matched task of the multi-dimensional bipartite graph matching solution; and
determine a largest quantity of matched edges from among the modified multi-dimensional augmenting tree orders corresponding to each un-matched task being a root node thereof.

12. The non-transitory computer-readable medium of claim 11, further including instructions executable on a processor to repeat the executable instructions of claim 11 for a multi-dimensional bipartite graph matching solution corresponding to the modified multi-dimensional augmenting tree order determined to have the largest quantity of matched edges.

13. A resource matching system, comprising:
one or more computing devices; and
non-transitory computer-readable medium communicatively coupled to the one or more computing devices, the non-transitory computer-readable medium including instructions executable on the one or more computing devices to:
logically arrange a plurality of relationships between a number of tasks and a quantity of resources into a multi-dimensional augmenting tree order, the relationships corresponding to edges of a multi-dimensional bipartite graph matching solution between nodes, representing tasks, and resources respectively, by:
establishing an un-matched task from the multi-dimensional bipartite graph matching solution as a root node,
adding additional edges and nodes beginning from the root node with an un-matched edge and alternating between matched and un-matched edges until a leaf node is a color-unmatched resource, and
modifying the multi-dimensional augmenting tree order by un-matching matched edges and matching un-matched edges; and
determine a quantity of matched edges for the modified multi-dimensional augmenting tree order.

14. The resource matching system of claim 13, wherein the non-transitory computer-readable medium includes instructions executable on the one or more computing devices to:
repeat the executable instructions of claim 13 for each un-matched task of the multi-dimensional bipartite graph matching solution; and
determine a largest quantity of matched edges from among the modified multi-dimensional augmenting tree orders corresponding to each un-matched task being a root node thereof.

15. The resource matching system of claim 14, further including instructions executable on the one or more computing devices to repeat the executable instructions of claim 14 for a multi-dimensional bipartite graph matching solution corresponding to the modified multi-dimensional augmenting tree order determined to have the largest quantity of matched edges.
